(19) United States
(12) Patent Application Publication
(10) Pub. No.: US 2016/0307251 A1
(43) Pub. Date: Oct. 20, 2016

(54) SMART CLOSET

(71) Applicant: MasterCard International Incorporated, Purchase, NY (US)

(72) Inventor: Justin Xavier Howe, San Francisco, CA (US)

(21) Appl. No.: 14/687,487

(22) Filed: Apr. 15, 2015

(51) Int. Cl. G06Q 30/06; G06F 17/30

(52) U.S. Cl. CPC G06Q 30/0623; G06F 17/30864

(57) ABSTRACT

A system and method of managing an individual's apparel inventory using cashless transaction data comprises defining a set of one or more transaction search keys associated with identification information of an individual, a cashless transaction device associated with an individual, or a cashless payment account associated with an individual, and searching a transaction data storage for cashless transactions corresponding with the search keys. The transaction data includes SKU-level data describing the substance of the goods or services transacted. These search results are filtered for transactions in which the substance of the transaction relates to apparel. The SKU-level data among the first filtered search results is examined to determine a size and gender profile corresponding with a first individual that corresponds with the articles of apparel reflected in the first filtered search results. A first virtual wardrobe corresponding to the first individual is populated by selecting from the first filtered search results, items of apparel consistent with the first size and gender profile.

### BACKGROUND

1. Field of the Disclosure

The present disclosure relates to electronic commerce. More specifically, the present disclosure is directed to method and system for managing and organizing an individual's clothing based at least in part upon SKU data derived from their purchase history.

2. Brief Discussion of Related Art

The idea of an intelligent ‘smart closet’ empowered by Radio Frequency Identification (RFID) tags embedded in clothing has existed for some time. Some extant solutions in the field may integrate weather forecasts, and/or your office calendar into recommending clothes for you to wear that day or beyond, for example if a user is scheduled to travel—with reference to the weather in the destination location. The system may suggest clothing ensembles to the user to avoid fashion faux pas, or compliment the user on a particular outfit. See, John Yang, Smart Closet Organizes Clothes, http://abcnews.go.com/WNT/story?id=131144.

Another solution is represented in U.S. Pat. No. 7,194,428 to Wan, et al. According to Wan's disclosure, the smart closet interacts with an RFID tag embedded in in each article of clothing. The smart closet track the user's wearing of a particular article by its removal from the closet. It can suggest matching items to a selected item. The closet may also infer the user's clothing needs, and suggest additional clothes to purchase. Wan contemplates web-enabled electronic commerce in further its operation.

There are other problems that could be ameliorated by a functional smart closet. For example, online retailers spend billions every year shipping apparel to customers that doesn't fit, or does not coordinate with the user's existing wardrobe. Then the retailer incurs the cost of restocking it, return shipping, and obsolescence—because the garment is never returned instantly.

None of the methods reviewed above looks at actual purchase history to assess wardrobe compatibility. None of the extant methods reviewed above can leverage all historical purchases of the card holder to generate the best possible recommendations. None of the methods reviewed above can leverage payment card refund data to detect mismatched merchandise and/or monitor wardrobe contents.

The present state of the art is therefore wanting.

### SUMMARY

As one means to address and reduce the problem of online clothing returns, the instant applicant and the instant inventor together filed U.S. patent application Ser. No. 13/841,276 on 15 Mar. 2013, entitled SKU-DRIVEN APPAREL SIZE DETERMINATION FOR CARDHOLDERS, published under U.S. Patent Application Publication No. 2014/0279194 on 18 Sep. 2014. The entire contents and disclosure of the aforementioned application and publication are hereby incorporated herein by this reference for all purposes.

In order to overcome these and other drawbacks in the present state of the art, proposed according to the present disclosure is a system and methods in which SKU-level transactional purchase data forms a basis to ascertain the contents of an individual's wardrobe. Details including size, color and style of a particular item purchased using a cashless transaction device are collected and mined for a wealth of purposes.

A great deal of money is spent every year shipping apparel that does not fit the intended customer. The retailer may then incur the cost of restocking it, return shipping, and obscelence (because the garment may not be returned instantly). If SKU level detail was known about each garment in a particular closet, retailers could make targeted purchase suggestions that are more likely to result in consummated sales that are not subsequently returned.

On the other hand, the SKU level data in purchase transactions is quite valuable. Apparel retailers will find it exceedingly valuable to access the purchase data of the entire market, not just their own sales. If any one of them has purchased an exclusive data feed to all of the SKUs in the closets of their customers, then they will know their customer's real-time purchase data contemporaneously with their competitors' limited knowledge of their own sales. At this point, whoever can imitate their competitors' best-selling items the fastest, and who has the fastest supply chain to enable them to do so, will end up with a distinct market advantage with respect to all customers.

Therefore, provided according to the present disclosure is a method of managing an individual's apparel inventory using cashless transaction data. The method comprises defining a set of one or more transaction search keys associated with identification information of an individual, a cashless transaction device associated with an individual, or a cashless payment account associated with an individual, and searching a transaction data storage for cashless transactions corresponding with the one or more search keys. Among the search results, the transaction data includes SKU-level data describing the substance of the goods or services transacted.

These search results are filtered based upon the SKU-level data for transactions in which the substance of the transaction relates to apparel to obtain first filtered search results. The SKU-level data among the first filtered search results is examined to determine a size and gender profile corresponding with a first individual that corresponds with the articles of apparel reflected in the first filtered search results. Having such a size/gender profile, a first virtual wardrobe corresponding to the first individual is populated by selecting from the first filtered search results, items of apparel consistent with the first size and gender profile.

In a further embodiment of the presently disclosed methods, filtering the first search results includes masking any purchased item in the first search results for which there is a corresponding return transaction to improve the accuracy of the wardrobe contents. In still a further embodiment of the presently disclosed methods, the contents of the first virtual wardrobe are masked among the first filtered search results to generate first masked filtered search results. The first masked, filtered search results are examined for SKU-level data to determine a second size and gender profile corresponding with a second individual that corresponds with the articles of apparel reflected in the first masked filtered search results. A second virtual wardrobe corresponding to the second individual is populated by selecting, from the first filtered search results, items of apparel consistent with the second size and gender profile.

In a further embodiment of the presently disclosed methods, a set of style rubrics is accessed that relates apparel of certain first characteristics with apparel of certain second characteristics. The style rubrics are applied to the contents of the first virtual wardrobe to determine if a first article of apparel in the first virtual wardrobe relates to a second article of apparel in the first virtual wardrobe according to the set of style rubrics. Any relation between the first and second articles of apparel is communicated to the first individual. In still a further embodiment of the presently disclosed method, the set of style rubrics is customized to a characteristic of the first individual.

In a further embodiment of the presently disclosed methods, consent is obtained from a first individual to share information describing the contents of the first virtual wardrobe. Optionally, access to a set of style rubrics that apparel of certain first characteristics with apparel of certain second characteristics is provided as compensation for the consent.

In still a further embodiment of the present disclosure, provided is a system for managing an individual's apparel inventory using cashless transaction data. The system comprises a machine-readable transaction data storage for cashless transactions, the transaction data including an identifier of the transaction device used in the cashless transaction, and SKU-level data describing the substance of the goods or services transacted, and a network-enabled computer having a processor and a machine-readable storage medium. The machine-readable storage medium storing thereon a program of instructions, which, when executed by the processor, cause the processor to execute one or more steps which has been already described hereinabove.

In still a further embodiment of the present disclosure, provided is a machine-readable storage medium, storing thereon a program of instructions, which, when executed by the processor, cause the processor to execute one or more steps which has been already described hereinabove.

These and other purposes, goals and advantages of the present disclosure will become apparent from the following detailed description of example embodiments read in connection with the accompanying drawings.

### BRIEF DESCRIPTION OF THE DRAWINGS

Some embodiments are illustrated by way of example and not limitation in the figure of the accompanying drawings, wherein

FIG. 1 represents, schematically, a system for managing an individual's apparel inventory using cashless transaction data according to the instant disclosure;

FIG. 2A illustrates a first portion of a flow chart diagramming a method for managing an individual's apparel inventory according to the instant disclosure, FIG. 2A being joined to FIG. 2B via off-page connector “A”; and

FIG. 2B illustrates a second portion of a flow chart diagramming a method for managing an individual's apparel inventory according to the instant disclosure, FIG. 2B being joined to FIG. 2A via off-page connector “A”;

### DETAILED DESCRIPTION

As used herein, a “payment device” will be understood to represent a payment card, i.e., calling to mind a credit card, debit card, ATM card, etc., which are in ubiquitous present use. However, those skilled in the art will appreciate the present disclosure is equally applicable to any cashless payment device, for example and without limitation magnetic stripe-bearing payment cards, PIN-based payment cards, contactless RFID-enabled devices including smart cards, NFC-enabled smartphones, virtual electronic and/or mobile cards and/or wallets, or the like.

As used herein, a “cardholder” is emblematic of any user of any such payment device, real or virtual. The payment device holder as payor, or other party having financial responsibility for a debit or credit account associated with the payment device, and/or said account which serves as the source of funds for the cashless payment.

As used herein, a “data warehouse” will be understood to represent any of a physical, virtual, consolidated, distributed means to store and make available for search and retrieval, transaction data related to a use of a purchase device to make payment for a cashless transaction.

As used herein, “SKU” will be understood as an acronym for the term “Stock Keeping Unit.” As used herein, “SKU-level data” will be understood to represent data descriptive of an identifiable good or service that is the subject of a cashless transaction. In certain instances, the goods may be one or more articles of apparel, such as clothing, footwear, fashion accessories or the like. Such data may include, without limitation, a description or indication of size, color, style, manufacturer (either by name, registered identification or “RN” number, or other designation), material, packaging, keyword, or any other characteristic of the article.

A first input to practicing the presently disclosed system and methods will be to establish, or have access to one already established, a database (or more colloquially, data warehouse) of transaction data. In particular, the database of transaction data can include transaction data drawn from the uses of a cashless payment device to consummate a purchase transaction. Such transaction data is commonly formatted according to ISO 8583, but as used herein may include a subset or some functional equivalent thereof. In particular, transaction data including SKU-level detail of products purchased, more particularly in the present case for articles of apparel, including without limitation, clothing, footwear, accessories, and the like, using the payment device as part of a cashless transaction. One skilled in the art will appreciate the known methods to link credit card purchase data to SKU-level data retained post purchase. For example, and without limitation, these include those matches made according to corresponding card and transaction time information, location and time matches, or matches made by store-time-basket price.

A second input to the presently disclosed method is a store or searchable database of descriptive SKU-level data with respect to, in the present instance, articles of apparel. Alternately, such descriptive SKU-level data can already be part and parcel of the transaction data already mentioned above. Particularly useful to the presently disclosed method, this SKU-level data includes descriptions or representations of the characteristics of the item with which it is associated. As to an article of apparel, e.g. and without limitation a garment or item of footwear, the SKU-level data may indicate one or more colors that feature in the item. Where there is an indication of more than one color in a single item, the colors may be ordered according to the degree in which each color appears on the garment. The data may indicate the item size. The data may indicate a material that comprises the item, e.g., cotton, wool, synthetic fiber textiles (e.g., nylon, rayon, spandex, etc.), or a trim fabric such as lace or tulle. The descriptive SKU-level data may include an open freeform keyword text field into which some indication of aesthetic design features of the article are placed, e.g., and without limitation, stripes (vertical or horizontal), solid color, checkered pattern, trim characteristics, etc. There may be a designation corresponding to a particular style with which the item is associated, e.g. and without limitation, formalwear, eveningwear, casual wear, etc.

A third input which can be useful, though not necessary, to the present disclosure is one or more sets of stylistic rubrics that can relate one item to another on the basis of the aforementioned SKU-level data. For example, one of such rubrics may provide that a garment that is predominantly blue should not be worn with another garment that is also predominantly blue, to avoid the colors clashing. Other rubrics may provide certain item characteristics whose combination is to be avoided. These style rubrics can be to a certain extent arbitrary. These sets of stylistic rubrics may even be customized, for example according to a particular source that can bear a brand and/or imprimatur of that source. Alternately or additionally, such rubric sets may be customized according to certain subsets of user, e.g., and without limitation, according to the age of the wearer, their aesthetic objectives, or body type, among other characteristics.

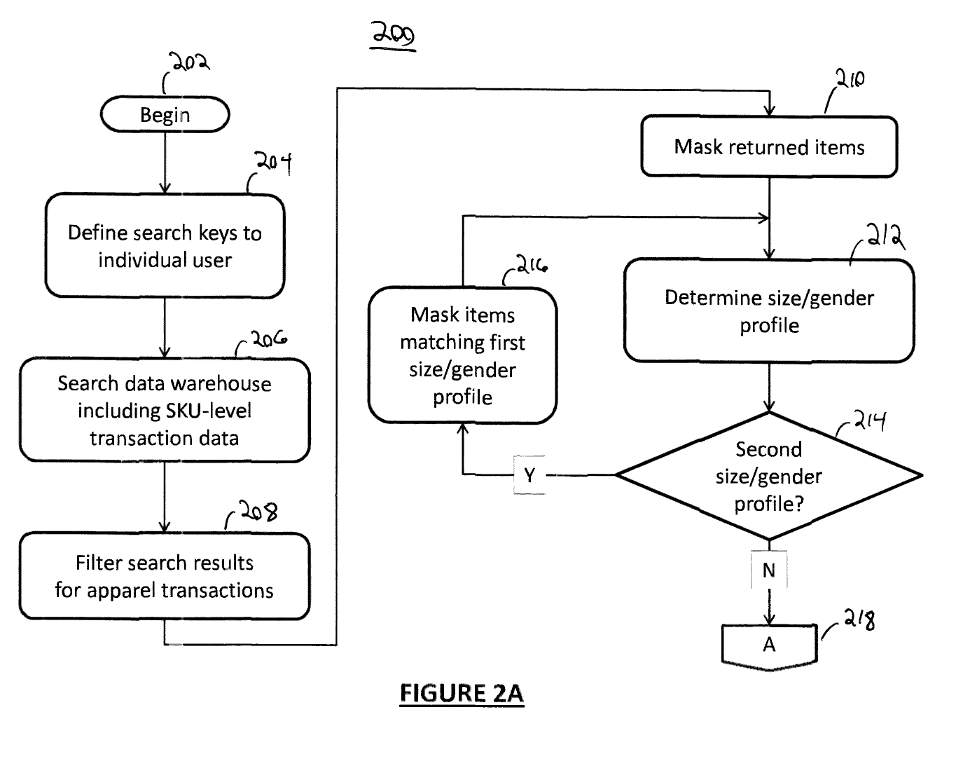

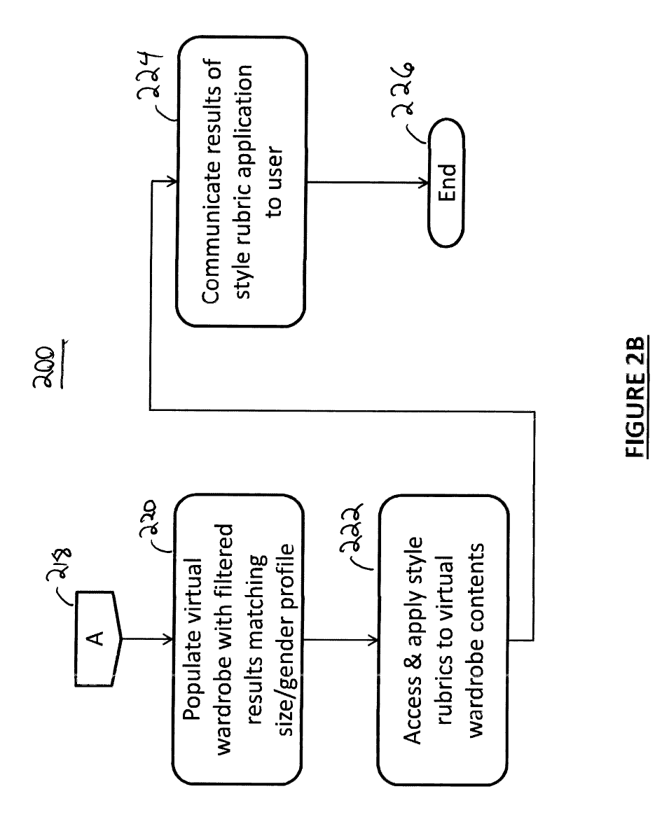

A method in accordance with the present disclosure then proceeds to use these resources as follows. We refer herein to the exemplary flowchart 200 depicted in combined FIGS. 2A and 2B. The method begins at 202. Transaction data from the data warehouse needs to be attributed to a particular individual. Accordingly, search keys for the individual are defined at step 204. One method of doing so is according to a transaction device identification number. Optionally, if a particular cardholder is known to have more than one transaction device, or plural accounts associated with one or more payment devices, then those accounts or transaction devices that are attributable to a common individual may be aggregated for more complete purchase data coverage. The search keys thus determined are used to search the data warehouse for transaction data associated with the individual at 206.

Those transactions will include goods and services of all types. Therefore, reference is made to the SKU-level data to filter the search results for transactions including only items of apparel at 208. More preferably, to improve accuracy, transactional data for a given transaction device, or for an aggregation of devices and accounts to a given individual, will be reviewed to determine if a purchased item was subsequently returned at 210. Any and all returned items will be masked in the data set at 210, such that the item subsequently returned is not considered as if in the inventory of the individual's virtual wardrobe.

The size/gender profile of the individual is determined at 212. Beginning from a verbose dataset of SKU-level data, such as one taken from hundreds if not thousands of retailers that has already been linked to payment card accounts, additional steps are required to determine which apparel is intended for the personal use of the cardholder. For example, a cardholder's apparel or footwear size need be determined. One method for ascertaining a user's apparel or footwear size has been set forth in the aforementioned SKU-DRIVEN APPAREL SIZE DETERMINATION FOR CARDHOLDERS, U.S. Patent Application Publication No. 2014/0279194. The individual and/or cardholder may be asked to provide this size and gender information instead of or in addition to the determination.

We note that the data set attributable to an individual user may support more than one wearer. For example, an individual may be the primary shopper not only for themselves, but also for a child, spouse, or other household member. Thus a decision is presented whether to identify a second size/gender profile from the transaction data, at 214. In the yes (“Y”) case, the size profile of a primary wearer is determined, for example, in the manner discussed above. Items consistent with that primary wearer size profile can be masked from the data set at 216, and another iteration of size and gender profile can be determined 212, presumably that of a secondary wearer. Moreover, if the secondary wearer has their own transaction device or account, it may be possible, and would be advantageous, to link the size profile of a secondary wearer on the first account with that individual's profile as determined from their transaction history using their own transaction device. In the no “N” case for a second size/gender profile determination, the process proceeds from decision 214.

Flowchart 200 of FIG. 2A joins FIG. 2B via off-page connector “A”, 218. Having determined a clothing size or gender of a particular wearer, the transaction record is culled to determine the items purchased, but more preferably, those items also not returned, that correspond to the determined size and gender profile. This size and gender information pertaining to the items purchased is taken from the above-mentioned database of SKU-level data. From this determination, the set of items meeting the criteria populates a virtual wardrobe for the first individual at 220.

Access to one or more style rubrics is negotiated at 222, and those style rubrics are applied to the contents of the virtual wardrobe. Any characterizations or advice running from the application of the style rubrics is communicated to the individual user at 224. Thereafter, a first embodiment of the process ends at 226. The process may be iterated at some interval, or in response to a trigger criterion, such as the purchase of an item of apparel.

Notably, and unlike the prior art systems discussed above, the presently disclosed system does not require that each article of apparel carry a machine-sensed (e.g., RFID) tag. However, in such cases where the apparel is so equipped, additional benefits flow from Applicant's present disclosure.

In particular, the machine-scanned contents of the wardrobe may be compared with the contents of the individual's virtual wardrobe as determined from transaction purchase data. The wardrobe management system may generate a reminder to the user of a putatively missing item—“Your blue top may be missing.” The user can respond appropriately, such as by indicating it was discarded, given to another wearer (either temporarily or permanently), or the reminder may alert the user that the article may have been forgotten, such as at a dry cleaner. The system can update the virtual wardrobe contents based upon a received user response.

Comparison of the virtual wardrobe contents with a detected wardrobe contents may provide opportunity for a virtual spring cleaning. For example, if a particular article of apparel has not left the user's closet in some arbitrary time frame, e.g., two years, it can be presumed that the user is likely not wear it again. Responsive to an appropriate communication, the user may respond that the item is no longer wanted, and has been or is being removed from the user's wardrobe. Spring cleaning recommendations may also be made based upon sizing mismatch between the contents of a virtual wardrobe, more recent purchases, and a size profile determined for the user. This sort of mismatch may suggest a body change in the user. The appropriate suggestion would be to discard older closing, and/or clothing of an obsolete size that is not likely to fit the user well any longer.

The benefits of the virtual wardrobe as already described above generally flow to the individual user, by way of improved wardrobe contents management, and/or access to fashion advice. Additional benefits of the present disclosure are also available, for example to apparel merchants. The individual may consent to share the informational contents of their virtual wardrobe with a merchant, for example, in exchange for access to one or more fashion rubrics, as described above. The merchant is then positioned to offer suggested merchandise to the individual for purchase. The suggested merchandise is tailored to integrate with the individual's size, expressed fashion desires as determined by a selected style rubric, and their extant wardrobe, all of which raises the likely purchase conversion rate.

A further benefit of the present disclosure to the merchant is based upon an aggregation of transaction data. An individual's transaction-based wardrobe contents, in the aggregate, can give a clothier nearly real-time market intelligence as to what items and corresponding styles are popular sellers. Some retailers may be positioned to geographically reallocate merchandise on hand, or to respond with similar styles from their own supply chain, in order to meet localized or widespread emerging market trends.

More particularly, the clothing recommendations can be made as part of an e-commerce payment platform, and offered as a service enhancement for customers making e-commerce clothing purchases online, for example, as an enticement to use a transaction card offering the recommendations in order to complete payment on the transaction, or optionally, as a stand-alone service. The service may be invoked by the retailer, either in-store or in an e-commerce transaction, with the customer providing their payment card details to the payment network operator, who makes the recommendation accordingly.

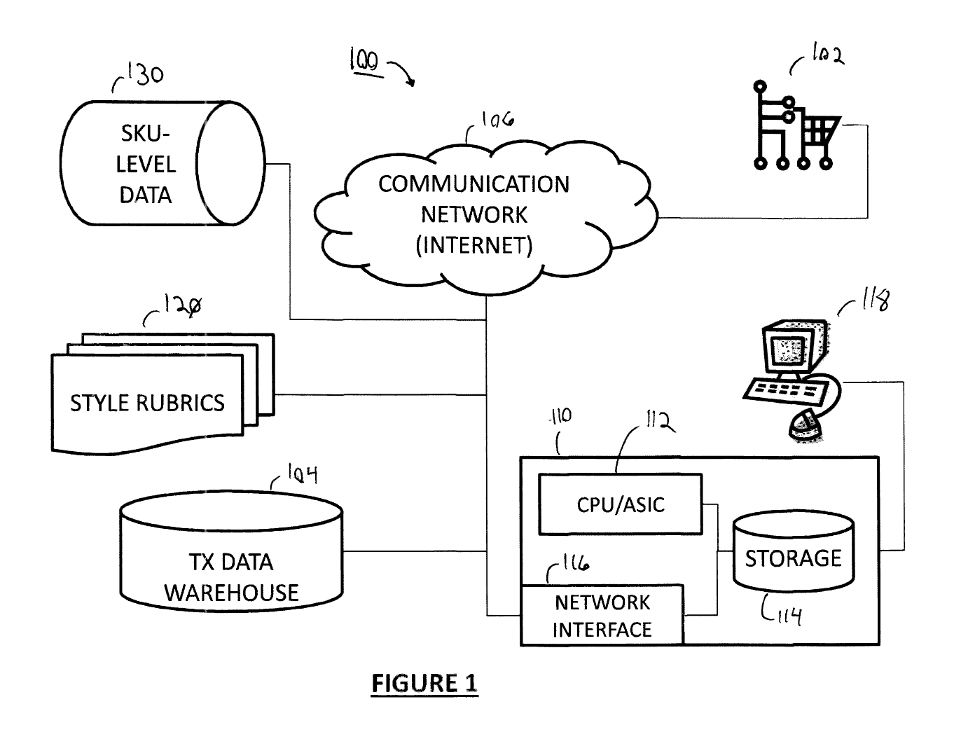

Turning then to FIG. 1, illustrated schematically is a system 100 according to the present disclosure. The cardholder or shopper in question is represented as 102. Their transaction data using a transaction device for cashless apparel purchases is stored in a data warehouse 104. One or more style rubrics 120 are accessible within the system 100, as are a store of SKU-level data 130, descriptive of articles of apparel that are the subject of the present disclosure. Any of the elements of the system 100 communicate with one another over links as shown and/or through a communication network 106, such as the internet, or secure virtual private channels over an open communication network 106, or outside an edge of the open network, for example as shown in the figure. The precise communication channel or means may be selected as is convenient to the user and/or operator of the system in view of the location of the data required.

The system 100 includes a computer 110 having at least a processor or CPU 112, which is operative to act on a program of instructions stored on a machine-readable storage medium 114. Execution of the program of instruction causes the processor 112 to carry out, for example, the methods described above according to the various embodiments hereinabove. The storage 114 may also be used to store information that is the result of the presently disclosed methods, for example the contents of a virtual wardrobe of a particular individual. That virtual wardrobe contents data may be searchable by individual or by item/SKU.

It may further or alternately be the case that the processor 112 comprises application-specific circuitry including the operative capability to execute the prescribed operations integrated therein. The computer 110 will in many cases includes a network interface 116 for communication with a communication network 106. Optionally or additionally, a suite of machine interface devices 118 facilitates human interaction with the server. The machine interface suite 118 may include data entry devices, e.g., keyboard, mouse, trackball, pointer, etc., and/or optional display. In other embodiments, the display and data entry device are integrated, for example a touch-screen display having a GUI.

Variants of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

I/We Claim:

1. A method of managing an individual's apparel inventory using cashless transaction data, the method comprising:
defining a set of one or more transaction search keys associated with identification information of an individual, a cashless transaction device associated with an individual, or a cashless payment account associated with an individual;
searching a transaction data storage for cashless transactions corresponding with the one or more search keys to produce a first search results, the transaction data including SKU-level data describing the substance of the goods or services transacted;
filtering the first search results based upon the SKU-level data for transactions in which the substance of the transaction relates to apparel to obtain first filtered search results;
examining the SKU-level data among the first filtered search results to determine a first size and gender profile corresponding with a first individual that corresponds with the articles of apparel reflected in the first filtered search results; and
populating a first virtual wardrobe corresponding to the first individual by selecting from the first filtered search results, items of apparel consistent with the first size and gender profile.

2. The method according to claim 1, wherein filtering the first search results includes masking any purchased item in the first search results for which there is a corresponding return or refund transaction.

3. The method according to claim 1, further comprising:
masking the contents of the first virtual wardrobe among the first filtered search results to generate first masked filtered search results;
examining the SKU-level data among the first masked filtered search results to determine a second size and gender profile corresponding with a second individual that corresponds with the articles of apparel reflected in the first masked filtered search results; and
populating a second virtual wardrobe corresponding to the second individual by selecting from the first filtered search results, items of apparel consistent with the second size and gender profile.

4. The method according to claim 1, further comprising
accessing a set of style rubrics that relate apparel having a first characteristic with apparel having a second characteristic;
applying the style rubrics to the contents of the first virtual wardrobe to determine if a first article of apparel in the first virtual wardrobe relates to a second article of apparel in the first virtual wardrobe according to the set of style rubrics; and
communicating the relation between the first and second articles of apparel to the first individual.

5. The method according to claim 4, wherein the set of style rubrics is customized to a characteristic of the first individual.

6. The method according to claim 1, further comprising:
obtaining consent from a first individual to share information describing the contents of the first virtual wardrobe.

7. The method according to claim 6, further comprising:
providing access to a set of style rubrics that relate apparel of certain first characteristics with apparel of certain second characteristics as compensation for the consent.

8. A system for managing an individual's apparel inventory using cashless transaction data, the system comprising:
a machine-readable transaction data storage for cashless transactions, the transaction data including an identifier of the transaction device used in the cashless transaction, and SKU-level data describing the substance of the goods or services transacted;
a network-enabled computer having a processor and a machine-readable storage medium, the machine-readable storage medium storing thereon a program of instructions, which, when executed by the processor, cause the processor to:
define a set of one or more transaction search keys associated with identification information of an individual, a cashless transaction device associated with an individual, or a cashless payment account associated with an individual;
search the transaction data storage for cashless transactions corresponding with the one or more search keys to produce a first search results, the transaction data including SKU-level data describing the substance of the goods or services transacted;
filter the first search results based upon the SKU-level data for transactions in which the substance of the transaction relates to apparel to obtain first filtered search results;
examine the SKU-level data among the first filtered search results to determine a first size and gender profile corresponding with a first individual that corresponds with the articles of apparel reflected in the first filtered search results; and
populate a first virtual wardrobe corresponding to the first individual by selecting from the first filtered search results, items of apparel consistent with the first size and gender profile.

9. The system according to claim 8, wherein the program of instructions further causes the processor to:
filter the first search results including masking any purchased item in the first search results for which there is a corresponding return transaction.

10. The system according to claim 8, wherein the program of instructions further causes the processor to:
mask the contents of the first virtual wardrobe among the first filtered search results to generate first masked filtered search results;
examine the SKU-level data among the first masked filtered search results to determine a second size and gender profile corresponding with a second individual that corresponds with the articles of apparel reflected in the first masked filtered search results; and
populate a second virtual wardrobe corresponding to the second individual by selecting from the first filtered search results, items of apparel consistent with the second size and gender profile.

11. The system according to claim 8, further comprising:
a machine-readable set of style rubrics that relate apparel of a first characteristic with apparel of a second characteristic,
wherein the program of instructions further causes the processor to access the set of style rubrics;
apply the style rubrics to the contents of the first virtual wardrobe to determine if a first article of apparel in the first virtual wardrobe relates to a second article of apparel in the first virtual wardrobe according to the set of style rubrics; and
communicate the relation between the first and second articles of apparel to the first individual.

12. The system according to claim 11, wherein the set of style rubrics is customized to a characteristic of the first individual.

13. The system according to claim 8, wherein the program of instructions further causes the processor to:
obtain consent from a first individual to share information describing the contents of the first virtual wardrobe.

14. The system according to claim 8, wherein the program of instructions further causes the processor to:
provide access to a set of style rubrics that relate at least one article of apparel in the first virtual wardrobe with a second article of apparel in the first virtual wardrobe, as compensation for the consent.

15. A machine-readable storage medium, storing thereon a program of instructions, which, when executed by a processor, cause the processor to:
define a set of one or more transaction search keys associated with identification information of an individual, a cashless transaction device associated with an individual, or a cashless payment account associated with an individual;
search a transaction data storage for cashless transactions corresponding with the one or more search keys to produce a first search results, the transaction data including SKU-level data describing the substance of the goods or services transacted;
filter the first search results based upon the SKU-level data for transactions in which the substance of the transaction relates to apparel to obtain first filtered search results;
examine the SKU-level data among the first filtered search results to determine a first size and gender profile corresponding with a first individual that corresponds with the articles of apparel reflected in the first filtered search results; and
populate a first virtual wardrobe corresponding to the first individual by selecting from the first filtered search results, items of apparel consistent with the first size and gender profile.

16. The medium according to claim 15, wherein the program of instructions further causes the processor to:
filter the first search results including masking any purchased item in the first search results for which there is a corresponding return transaction.

17. The medium according to claim 15, wherein the program of instructions further causes the processor to:
mask the contents of the first virtual wardrobe among the first filtered search results to generate first masked filtered search results;
examine the SKU-level data among the first masked filtered search results to determine a second size and gender profile corresponding with a second individual that corresponds with the articles of apparel reflected in the first masked filtered search results; and
populate a second virtual wardrobe corresponding to the second individual by selecting from the first filtered search results, items of apparel consistent with the second size and gender profile.

18. The medium according to claim 15, further comprising:
a machine-readable set of style rubrics that relate apparel of a first characteristic with apparel of a second characteristic,
wherein the program of instructions further causes the processor to access the set of style rubrics;
apply the style rubrics to the contents of the first virtual wardrobe to determine if a first article of apparel in the first virtual wardrobe relates to a second article of apparel in the first virtual wardrobe according to the set of style rubrics; and
communicate the relation between the first and second articles of apparel to the first individual.

19. The medium according to claim 18, wherein the set of style rubrics is customized to a characteristic of the first individual.

20. The medium according to claim 19, wherein the program of instructions further causes the processor to:
obtain consent from a first individual to share information describing the contents of the first virtual wardrobe.

21. The medium according to claim 15, wherein the program of instructions further causes the processor to:
provide access to a set of style rubrics that relate at least one article of apparel in the first virtual wardrobe with a second article of apparel in the first virtual wardrobe, as compensation for the consent.
